(19) United States
(12) Patent Application Publication
(10) Pub. No.: US 2025/0173822 A1
(43) Pub. Date: May 29, 2025

(54) TRAJECTORY-AWARE TRANSFORMER FOR VIDEO SUPER-RESOLUTION

(71) Applicant: Microsoft Technology Licensing, LLC, Redmond, WA (US)

(72) Inventors: Jianlong FU, Beijing (CN); Huan YANG, Beijing (CN)

(73) Assignee: Microsoft Technology Licensing, LLC, Redmond, WA (US)

(21) Appl. No.: 18/841,831

(22) PCT Filed: Mar. 29, 2022
(86) PCT No.: PCT/CN2022/083832

§ 371 Date: Aug. 27, 2024

(51) Int. Cl. G06T 3/4046; G06T 3/4053; G06T 7/246

(52) U.S. Cl. CPC G06T 3/4046; G06T 3/4053; G06T 7/248; G06T 2207/10016; G06T 2207/20081; G06T 2207/20084; G06T 2207/30241

(57) ABSTRACT

A computing system comprises a processor and memory storing instructions executable by the processor to obtain a sequence of image frames in a video. A target image frame of the sequence are input into a visual token embedding network of a trajectory-aware transformer to output a plurality of query tokens. A plurality of different image frames are input into a motion estimation network, the visual token embedding network, and a value embedding network to output a location map for each image frame, a plurality of key tokens, and a plurality of value embeddings, respectively. An image frame is selected the plurality of different image frames that has a closest similarity value from among the plurality of key tokens, and a super-resolution image frame is generated at a target time step as a function of an index query token, a value embedding of the selected frame, and the target image frame.

### BACKGROUND

Super-resolution techniques aim to restore high-resolution (HR) image frames from their low-resolution (LR) counterparts. For example, video super-resolution techniques attempt to discover detailed textures from various frames in a LR image sequence, which may be leveraged to recover a target frame and enhance video quality. However, it can be challenging to process large sequences of images. Thus, a technical challenge exists to harness information from distant frames to increase resolution of the target frame.

### SUMMARY

To address this challenge, according to one aspect of the present disclosure a computing system is disclosed that comprises a processor and a memory storing instructions executable by the processor to obtain a sequence of image frames in a video. Each image frame of the sequence corresponds to a time step of a plurality of time steps. A target image frame of the sequence is input into a visual token embedding network of a trajectory-aware transformer to thereby cause the visual token embedding network to output a plurality of query tokens. A plurality of different image frames are input into a motion estimation network of the trajectory-aware transformer to thereby cause the motion estimation network to output, for each image frame, a location map that indicates a location within the image frame that corresponds to an index location within the target image frame that has moved along a trajectory between the image frame and the target image frame. The plurality of different image frames are input into the visual token embedding network to thereby cause the visual token embedding network to output a plurality of key tokens. The plurality of different image frames are input into a value embedding network of the trajectory-aware transformer to thereby cause the value embedding network to output a plurality of value embeddings. For each key token along the trajectory, the computing system is configured to compute a similarity value to a query token at the index location. An image frame is selected from the plurality of different image frames that has a closest similarity value from among the plurality of key tokens. A super-resolution image frame is generated at the target time step as a function of the query token, a value embedding of the selected frame at a location corresponding to the index location, the closest similarity value, and the target image frame.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an example of a computing system for generating a super-resolution image frame from a sequence of low-resolution images.

FIG. 2 shows an example of an image sequence that can be used by the computing system of FIG. 1, and an example of a super-resolution image that can be output by the computing system of FIG. 1.

FIG. 3 shows an example of a trajectory and corresponding location maps for a sequence of images that can be used by the computing system of FIG. 1.

FIG. 4 shows examples of super-resolution image frames that can be generated by the computing system of FIG. 1 and image frames generated using other methods.

FIGS. 5A-5C show a flowchart of an example method for generating a super-resolution image frame from a sequence of low-resolution images.

FIG. 6 shows a schematic diagram of an example computing system, according to one example embodiment.

### NON-PATENT LITERATURE

[NPL1] Xintao Wang, Kelvin C K Chan, Ke Yu, Chao Dong, and Chen Change Loy. EDVR: Video restoration with enhanced deformable convolutional networks. In CVPRW, 2019.
[NPL2] Yapeng Tian, Yulun Zhang, Yun Fu, and Chenliang Xu. TDAN: Temporally-deformable alignment network for video super-resolution. In CVPR, pp. 3360-3369, 2020.
[NPL3] Sheng Li, Fengxiang He, Bo Du, Lefei Zhang, Yonghao Xu, and Dacheng Tao; Fast spatio-temporal residual network for video super-resolution, in CVPR, pp. 10522-10531, 2019.
[NPL4] Takashi Isobe, Songjiang Li, Xu Jia, Shanxin Yuan, Gregory Slabaugh, Chunjing Xu, Ya-Li Li, Shengjin Wang, and Qi Tian; Video super-resolution with temporal group attention, in CVPR, pp. 8008-8017, 2020.
[NPL5] Jose Caballero, Christian Ledig, Andrew Aitken, Alejandro Acosta, Johannes Totz, Zehan Wang, and Wenzhe Shi; Real-time video super-resolution with spatio-temporal networks and motion compensation, in CVPR, pp. 4778-4787, 2017.
[NPL6] Mehdi S M Sajjadi, Raviteja Vemulapalli, and Matthew Brown; Frame-recurrent video super-resolution, in CVPR, pp. 6626-6634, 2018.
[NPL7] Muhammad Haris, Gregory Shakhnarovich, and Norimichi Ukita; Recurrent back-projection network for video super-resolution, in CVPR, pp. 3897-3906, 2019.
[NPL8] Takashi Isobe, Xu Jia, Shuhang Gu, Songjiang Li, Shengjin Wang, and Qi Tian; Video super-resolution with recurrent structure-detail network, in ECCV, pp. 645-660, 2020.
[NPL9] Peng Yi, Zhongyuan Wang, Kui Jiang, Junjun Jiang, Tao Lu, Xin Tian, and Jiayi Ma; Omniscient video super-resolution, arXiv:2103.15683, 2021.
[NPL10] Kelvin C K Chan, Xintao Wang, Ke Yu, Chao Dong, and Chen Change Loy; BasicVSR: The search for essential components in video super-resolution and beyond, in CVPR, pp. 4947-4956, 2021.
[NPL11] Alexey Dosovitskiy, Lucas Beyer, Alexander Kolesnikov, Dirk Weissenborn, Xiaohua Zhai, Thomas Unterthiner, Mostafa Dehghani, Matthias Minderer, Georg Heigold, Sylvain Gelly, et al.; An image is worth 16×16 words: transformers for image recognition at scale, arXiv:2010.11929, 2020.
[NPL12] Fuzhi Yang, Huan Yang, Jianlong Fu, Hongtao Lu, and Baining Guo; Learning texture transformer network for image super-resolution, in CVPR, pp. 5791-5800, 2020.
[NPL13] Jiezhang Cao, Yawei Li, Kai Zhang, and Luc Van Gool; Video super-resolution transformer, arXiv:2106.06847, 2021.
[NPL14] Wenbo Li, Xin Tao, Taian Guo, Lu Qi, Jiangbo Lu, and Jiaya Jia; MuCAN: Multi-correspondence aggregation network for video super-resolution, in ECCV, pp. 335-351, 2020.
[NPL15] Anurag Ranjan and Michael J Black; Optical flow estimation using a spatial pyramid network, in CVPR, pp. 4161-4170, 2017.
[NPL16] Peng Yi, Zhongyuan Wang, Kui Jiang, Junjun Jiang, and Jiayi Ma; Progressive fusion video super-resolution network via exploiting non-local spatio-temporal correlations, in ICCV, pp. 3106-3115, 2019.
[NPL17] Yulun Zhang, Kunpeng Li, Kai Li, Lichen Wang, Bineng Zhong, and Yun Fu; Image super-resolution using very deep residual channel attention networks, in ECCV, pp. 286-301, 2018.
[NPL18] Yiqun Mei, Yuchen Fan, Yuqian Zhou, Lichao Huang, Thomas S Huang, and Honghui Shi; Image super-resolution with cross-scale non-local attention and exhaustive self-exemplars mining, in CVPR, pp. 5690-5699, 202.
[NPL19] Tianfan Xue, Baian Chen, Jiajun Wu, Donglai Wei, and William T Freeman; Video enhancement with task-oriented flow, IJCV, 127(8):1106-1125, 2019.
[NPL20] Younghyun Jo, Seoung Wug Oh, Jaeyeon Kang, and Seon Joo Kim; Deep video super-resolution network using dynamic upsampling filters without explicit motion compensation, in CVPR, pp. 3224-3232, 2018.
[NPL21] Seungjun Nah, Sungyong Baik, Seokil Hong, Gyeongsik Moon, Sanghyun Son, Radu Timofte, and Kyoung Mu Lee; Ntire 2019 challenge on video deblurring and super-resolution: Dataset and study, in CVPRW, 2019.
[NPL22] Tianfan Xue, Baian Chen, Jiajun Wu, Donglai Wei, and William T Freeman; Video enhancement with task-oriented flow, IJCV, 127(8):1106-1125, 2019.
[NPL 23] Ce Liu and Deqing Sun; On bayesian adaptive video super resolution, IEEE TPAMI, 36(2):346-360, 2013.

### DETAILED DESCRIPTION

As introduced above, super-resolution techniques may be used to output high-resolution (HR) image frames given a sequence of low-resolution (LR) images. For example, video super-resolution (VSR) techniques attempt to construct a sequence of HR image frames by assembling detailed textures discovered from various frames in a LR image sequence. Such techniques may be valuable in many applications, such as video surveillance, high-definition cinematography, and satellite imagery.

In some examples, VSR approaches attempt to utilize adjacent frames (e.g., a sliding window of 5-7 frames adjacent to the target frame) as inputs, aligning temporal features in an implicit or explicit manner. They mainly focus on using a two-dimensional (2D) or three-dimensional (3D) convolutional neural network (CNN), and optical flow estimation or deformable convolutions to design advanced alignment modules and fuse detailed textures from adjacent frames. For example, Enhanced Deformable Video Restoration (EDVR-[NPL1]) and Temporally-Deformable Alignment Network (TDAN-[NPL2]) adopt deformable convolutions to align adjacent frames and capture features within a sliding window. To utilize complementary information across frames, Fast Spatio-Temporal Residual Network (FSTRN-[NPL3]) adopts 3D convolutions. Temporal Group Attention (TGA-[NPL4]) divides input into several groups and incorporates temporal information in a hierarchical way. To align adjacent frames, VESCPN ([NPL5]) introduces a spatio-temporal sub-pixel convolution network and combines motion compensation and VSR algorithms together. However, it can be challenging to utilize textures at other timesteps with these techniques, especially from relatively distant frames (e.g., greater than 5-7 frames away from a target frame), because expanding the sliding window to encompass more frames will dramatically increase computational costs.

In other examples, rather than aggregating information from adjacent frames, methods based on a recurrent structure use a hidden state to convey relevant information in previous frames. For example, Frame-Recurrent Video Super-Resolution (FRVSR-[NPL6]) uses a previous super-resolution (SR) frame to recover a subsequent frame. Inspired by back projection, Recurrent Back-Projection Network (RBPN-[NPL7]) treats each frame as a separate source, which is combined in an iterative refinement framework. Recurrent Structure-Detail Network (RSDN-[NPL8]) divides input into structure and detail components and utilizes a two-steam structure-detail block to learn textures. Omniscient Video Super-Resolution (OVSR-[NPL9]), BasicVSR and Icon-VSR ([NPL10]) fuse a bidirectional hidden state from the past and future for reconstruction. These techniques attempt to fully utilize the whole sequence and synchronously update the hidden state by the weights of the reconstruction network. Nonetheless, recurrent networks lose long-term modeling capabilities to some extent due to the vanishing gradient problem.

In yet other examples, transformer models are used to model long-term sequences. In the field of computer vision, a transformer models relationships between tokens in image-based tasks, such as image classification, object detection, inpainting, and image super-resolution. For example, ViT ([NPL11]) unfolds an image into patches as tokens for attention to capture long-range relationships in high-level vision. TTSR ([NPL12]) uses a texture transformer in low-level vision to search relevant texture patches from a reference image to apply to a LR image. In VSR tasks, VSR-Transformer (VSR-T-[NPL13]) and MuCAN ([NPL14]) attempt to use attention mechanisms for aligning different frames. However, due to the heavy computational costs of attention calculation on videos, such mechanisms aggregate information from a relatively narrow temporal window. Thus, a technical challenge exists to leverage information from temporally distant frames for VSR.

To address these issues, examples are disclosed that relate to utilizing a trajectory-aware transformer to enable effective video representation learning for VSR (TTVSR). A motion estimation network is utilized to formulate video frames into several pre-aligned trajectories which comprise continuous visual tokens. For a query token, self-attention is learned on relevant visual tokens along spatio-temporal trajectories. This approach significantly reduces computational cost compared with conventional vision transformers and enables a transformer to model long-range features. Further, and as described in more detail below, a cross-scale feature tokenization module is utilized to address changes in scale that may occur in long-range videos. Experimental results demonstrate that TTVSR outperforms other techniques in four VSR benchmarks.

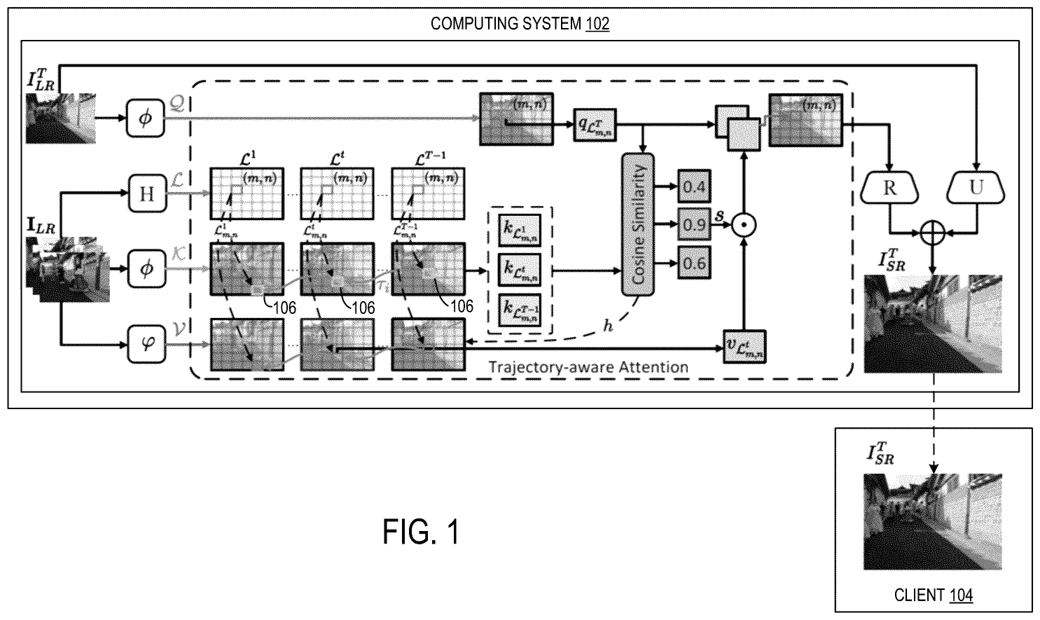

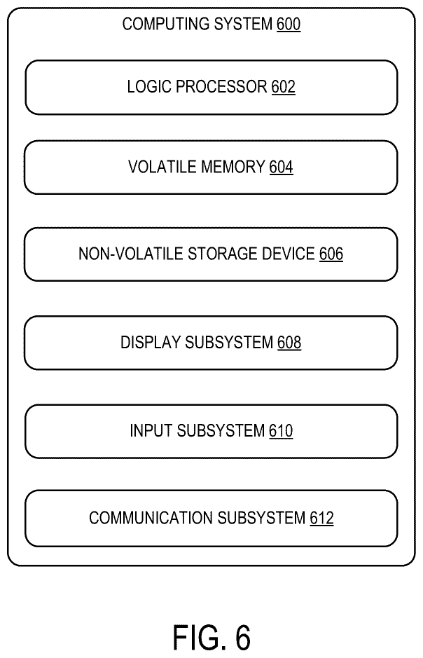

FIG. 1 shows an example of a computing system 102 for generating a super-resolution image frame (I_{SR}^{T}). In some examples, the computing system 102 comprises a server computing system (e.g., a cloud-based server or a plurality of distributed cloud servers). In other examples, the computing system 102 may comprise any other suitable type of computing system. Other examples of suitable computing systems include, but are not limited to, a desktop computer and a laptop computer. Additional aspects of the computing system 102 are described in more detail below with reference to FIG. 6.

The computing system 102 is optionally configured to output the super-resolution image frame (I_{SR}^{T}) to a client 104. In some examples, the client 104 comprises a computing system separate from the computing system 102. Some examples of suitable computing systems include, but are not limited to, a desktop computing device, a laptop computing device, or a smartphone. The client 104 may including a processor that executes an application program (e.g., a video player or a video conferencing application). Additional aspects of the client 104 are described in more detail below with reference to FIG. 6.

To generate the super-resolution image frame (I_{SR}^{T}), the computing system 102 is configured to obtain a sequence of image frames in a video. Each image frame of the sequence corresponds to a time step of a plurality of time steps. In some examples, the sequence of the image frames comprises a video, such as a prerecorded video, a streaming video, or a video conference. Each image frame of the sequence is a LR image frame relative to the super-resolution image frame (I_{SR}^{T}). Given the sequence of LR image frames, the computing system 102 is configured to generate a HR version (e.g., I_{SR}^{T}) of one or more target frames (e.g., I_{LR}^{T}, which corresponds to the super-resolution image frame I_{SR}^{T}) using image textures recovered from one or more different image frames denoted herein as I_{LR} {I_{LR}^{t}, t∈[1, T−1]}.

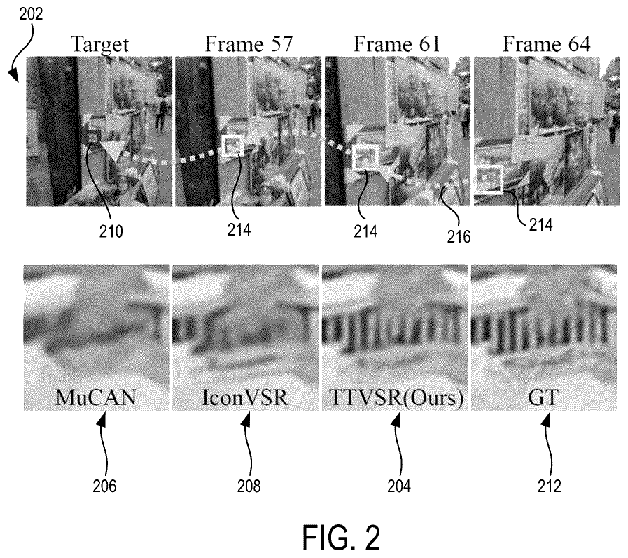

FIG. 2 shows another example of an image sequence 202 comprising a plurality of image frames. FIG. 2 also shows portions of super-resolution images 204-208 generated for a boxed area 210 in a target frame using TTVSR (204) relative to other methods (MuCAN (206) and Icon-VSR (208)) and a ground truth (GT) HR image 212. As illustrated by example in FIG. 2, finer textures are introduced into the super-resolution image from corresponding boxed areas 214 in relatively distant frames (e.g., frames 57, 61, and 64), which are tracked by a trajectory 216. As depicted in the example of FIG. 2, the quality of the image 204 constructed using TTVSR is more similar to ground truth 212 on a qualitative basis than the images 206 and 208 constructed using MuCAN and Icon-VSR, respectively.

With reference again to FIG. 1, and to generate the super-resolution image frame (I_{SR}^{T}), the computing system 102 is configured to input a target image frame I_{LR}^{T} for a target time step of the sequence into a visual token embedding network Φ of a trajectory-aware transformer to thereby cause the visual token embedding network Φ to output a plurality of query tokens Q. In some examples, the visual token embedding network Φ is used to extract the query tokens Q by a sliding window method. Additional aspects of the visual token embedding network Φ, including training, are described in more detail below. The query tokens Q are denoted as Q=Φ(I_{LR})={qᵢ^{T}, i∈[1, N]}.

The computing system 102 is further configured to input a plurality of different image frames I_{LR} into the visual token embedding network P to thereby cause the visual token embedding network Φ to output a plurality of key tokens K. The visual token embedding network Φ is the same network Φ that is used to generate the plurality of query tokens Q. The use of the same network Φ enables comparison between the query tokens Q and the key tokens K. In some examples, the visual token embedding network Φ is used to extract the key tokens K by a sliding window method. The key tokens K are denoted as K=Φ(I_{LR})={kᵢ^{t}, i∈[1, N], t|[1, T−1]}.

The plurality of different image frames I_{LR} are also input into a value embedding network φ of the trajectory-aware transformer to thereby cause the value embedding network φ to output a plurality of value embeddings V. In some examples, the value embedding network φ is used to extract the value embeddings V by a sliding window method. Additional aspects of the value embedding network p, including training, are described in more detail below. The value embeddings V are denoted as V=φ(I_{LR})={vᵢ^{t}, i∈[1, N], t∈[1, T−1]}.

In some examples, the computing system 102 is configured to cross-scale image feature tokens (e.g., q, k, and v). In a long-range video, complex motions may be accompanied by changes in scale at the same time. It will be understood that textures from a larger scale can help to recover textures on a smaller scale. Therefore, cross-scaling allows tokens to be extracted from multiple scales.

To extract tokens, in some examples, successive unfold and fold operations are used to expand the receptive field of features. Second, features from different scales are shrunk to the same scale by a pooling operation. Third, the features are split by an unfolding operation to obtain the output tokens. This process can extract features from a larger scale while maintaining the size of the output tokens, which simplifies attention calculation and token integration.

As introduced above, self-attention is learned on relevant visual tokens along spatio-temporal trajectories [symbol] . The trajectories [symbol] can be formulated as a set of trajectories σᵢ, in which each trajectory σᵢ is a sequence of coordinates over time and the end point of trajectory σᵢ is associated with the coordinate of query token qᵢ:

$$T = \{ {τ}_{i} , i ∈ [ 1 , N ] \} , {τ}_{i} = 〈 {τ}_{i}^{t} = ( {x}_{i}^{t} , {y}_{i}^{t} ) , t ∈ [ 1 , T - 1 ] 〉 . \qquad ( 1 )$$

Here, σᵢ^{t}∈[1, H], yᵢ^{t}∈[1, W], and (xᵢ^{t}, yᵢ^{t}) represents the coordinate of trajectory σᵢ at time t. H and W represent the height and width of the feature maps, respectively.

From the aspect of trajectories, the inputs to the trajectory-aware transformer can be further represented as visual tokens which are aligned by trajectories [symbol] :

$$𝒥 = \{ {τ}_{i} , i ∈ [ 1 , N ] \} , Q = \{ {q}_{{τ}_{i}^{T}} , i ∈ [ 1 , N ] \} , K = \{ {k}_{{τ}_{i}^{t}} , i ∈ [ 1 , N ] , t ∈ [ 1 , T - 1 ] \} , V = \{ {v}_{{τ}_{i}^{t}} , i ∈ [ 1 , N ] , t ∈ [ 1 , T - 1 ] \} . \qquad ( 2 )$$

Some approaches to calculate trajectories of objects through space and time, such as feature alignment and global optimization, are time-consuming and inefficient. This is especially true for trajectories that are updated over time, in which computational cost can explode. Accordingly, and in one potential advantage of the present disclosure, a set of location maps is used for trajectory generation, in which the location maps are represented as a group of matrices over time. In this manner, the trajectory generation can be expressed in terms of matrix operations, which are computationally efficient and easy to implement in the models described herein.

To obtain the location maps, the computing system 102 is configured to input the plurality of different image frames I_{LR} into a motion estimation network H of the trajectory-aware transformer to thereby cause the motion estimation network H to output, for each image frame I_{LR}^{t}, a location map [symbol] ^{t} that indicates a location, within the image frame that corresponds to an index location [symbol] _{m,n}^{T} within the target image frame that has moved along a trajectory σᵢ between the image frame I_{LR}^{t} and the target image frame I_{LR}^{T}. Equation (3) shows an example formulation of location maps [symbol] ^{t}, in which the time is fixed to T for simplicity:

$${ℒ}^{t} = [ \begin{matrix}( {x}_{1} , {y}_{1} ) & … & ( {x}_{1} , {y}_{W} ) \\ … & … & … \\ ( {x}_{H} , {y}_{1} ) & … & ( {x}_{H} , {y}_{W} )\end{matrix} ] , t ∈ [ 1 , T ] . \qquad ( 3 )$$

Here, each location map [symbol] ^{t} comprises a matrix of locations within a respective image frame that each correspond to a target index location within the target image frame. As described in more detail below, the location maps can be used to compute a trajectory σᵢ using matrix operations. This allows the trajectory σᵢ to be generated in a lightweight and computationally efficient manner relative to the use of other techniques, such as feature alignment and global optimization.

In the location maps [symbol] ^{t}, the target index location [symbol] _{m,n}^{T} is indicated by a position of a respective location element in the matrix. [symbol] _{m,n}^{t} represents the coordinate at time t in a trajectory which ends at (m, n) at time T. Time T corresponds to a timestep of the target image frame I_{LR}^{T}. The relationship between the location map [symbol] _{m,n}^{t} and the trajectory σᵢ^{T} of equation (1) can be further expressed as:

$${ℒ}_{m , n}^{t} = {τ}_{i}^{T} , where {τ}_{i}^{T} = ( m , n ) , i ∈ [ 1 , N ] . \qquad ( 4 )$$

Here, m∈[1, H] and n∈[1, W].

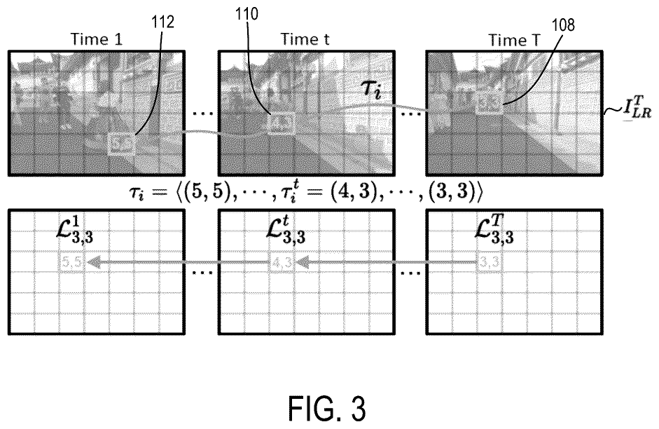

FIG. 3 shows an example of a trajectory σᵢ and corresponding location maps [symbol] at time t for the sequence of images shown in FIG. 1. Box 108, which has coordinates of (3,3) at time T, includes an index feature of the target image frame I_{LR}^{T}. Accordingly, a location map [symbol] ^{T} is initialized for the target image frame I_{LR}^{T}, such that the location map [symbol] ^{T} evaluates to (3,3) at position (3,3).

At time t, the index feature that was located at (3,3) in the target image frame I_{LR}^{T} has moved relative to the field of view of the image frame to a second box 110 having coordinates (4,3). Accordingly, the location map [symbol] ^{t} at time t evaluates to (4,3) at position (3,3), where position (3,3) of the location map represents the target index location [symbol] _{m,n}^{T} of the index feature at time T. Similarly, at time 1, the index feature that was located at (3,3) in the target image frame I_{LR}^{T} is located within a third box 112 having coordinates (5,5). Accordingly, the location map [symbol] ¹ evaluates to (5,5) at position (3,3). Advantageously, the location of the index feature along trajectory σᵢ can be determined by reading the location map at the position corresponding to the location of the index feature at time T.

When moving from time T to time T+1, a new location map * [symbol] ^{T+1} at time T+1 is initialized. Based on equation (4), * [symbol] _{m,n}^{T+1} represents the coordinate at time T+1 of a trajectory which ends at (m, n) at time T+1, which can be expressed as:

$$* {ℒ}_{m , n}^{T + 1} = ( m , n ) . \qquad ( 5 )$$

The existing location maps { [symbol] _{m,n}¹, . . . , [symbol] _{m,n}^{T}} are updated accordingly.

To build the connection of trajectories between time T and time T+1, the motion estimation network H computes a backward flow O_{T+1} from I_{LR}^{T+1} to I_{LR}^{T}. This process can be formulated as:

$${O}_{T + 1} = H ( {I}_{LR}^{T + 1} , {I}_{LR}^{T} ; θ ) . \qquad ( 6 )$$

Here, H is the motion estimation network with parameter θ and an average pooling operation. The average pooling is used to ensure that the output of the motion estimation network is the same size as [symbol] ^{t}.

In some examples, the motion estimation network H comprises a neural network. One example of a suitable neural network includes, but is not limited to, a spatial pyramid network such as SPYNET. As described in more detail below, the neural network is configured to output an optical flow (e.g., O_{T+1}) between a run-time input image frame and a successive run-time input image frame. The optical flow output by the spatial pyramid network indicates motion of an image feature (e.g., an object, an edge, or a patch comprising a portion of an image frame) between the run-time input image frame and the successive run-time input image frame. Based on the spatial correlation built by the backward flow O_{T+1}, the coordinates in location map [symbol] ^{T+1} can be back tracked from time T+1 to time T. As the correlations in flow may be float numbers, the updated coordinates in location map [symbol] ^{t} can be obtained by interpolating between adjacent coordinates.

$$* {ℒ}^{t} = S ( {ℒ}^{t} , {O}_{T + 1} ) . \qquad ( 7 )$$

Here, S represents a spatial sampling matrix operation, which may be integrated with the motion estimation network H. The spatial sampling matrix operation is configured to transform coordinates in a location map corresponding to the successive run-time input image frame to thereby generate an updated location map corresponding to the run-time input image frame based upon the optical flow. One example of a suitable spatial sampling matrix operation includes, but is not limited to, grid sample in PYTORCH provided by Meta Platforms, Inc. of Menlo Park, California. Execution of S on matrix [symbol] ^{t} by spatial correlation O_{T+1} results in the updated location map for time T+1. Accordingly, and in one potential advantage of the present disclosure, the trajectories [symbol] can be effectively calculated and maintained through one parallel matrix operation (e.g., the operation S).

In contrast to traditional attention mechanisms that take a weighted sum of temporal keys, the trajectory-aware attention module uses hard attention to select the most relevant token along trajectories. This can reduce blur introduced by weighted sum methods. As described in more detail below, soft attention is used to generate the confidence of relevant patches. This can reduce the impact of irrelevant tokens. The following paragraphs provide an example formulation for the hard attention and soft attention computations.

To compute the hard attention and soft attention, the computing system 102 of FIG. 1 is configured to, for each key token kᵢ^{t} along the trajectory σᵢ, compute a similarity value to a query token qᵢ^{T} at the index location. In some examples, and as depicted in FIG. 1, computing the similarity value comprises computing a cosine similarity value between the query token qᵢ^{T} at the index location and each key token kᵢ^{t} along the trajectory ii. The calculation process can be formulated as:

$${h}_{{τ}_{i}} = {arg max}_{t} 〈 \frac{{q}_{{τ}_{i}^{T}}}{{‖ {q}_{{τ}_{i}^{T}} ‖}_{2}^{2}} , \frac{{k}_{{τ}_{i}^{t}}}{{‖ {k}_{{τ}_{i}^{T}} ‖}_{2}^{2}} 〉 , {s}_{{τ}_{i}} = {max}_{t} 〈 \frac{{q}_{{τ}_{i}^{T}}}{{‖ {q}_{{τ}_{i}^{T}} ‖}_{2}^{2}} , \frac{{k}_{{τ}_{i}^{t}}}{{‖ {k}_{{τ}_{i}^{T}} ‖}_{2}^{2}} 〉 . \qquad ( 8 )$$

Here, h_{σ}_{ᵢ} and s_{σ}_{ᵢ} represent the results of hard and soft attention, respectively. The hard attention operation h_{σ}_{ᵢ} is configured to select an image frame from the plurality of different image frames that has a closest similarity value from among the plurality of key tokens kᵢ^{t}. The closest similarity value may be a highest or maximum similarity value among the plurality of key tokens. This image frame includes the most similar texture to the query token qᵢ^{T} and is thus the most relevant image frame out of the sequence to obtain information for reconstructing a portion of the target image frame represented by the query key. The selected image frame may be specific to a selected query token qᵢ^{T} within the target frame. It will also be appreciated that the frame with the most similar key may be different for different query tokens within the target frame.

Following the attention computations, the computing system 102 is further configured to generate the super-resolution image frame I_{SR}^{T} at the target time step as a function of the query token, a value embedding vᵢ^{t} of the selected frame at a location corresponding to the index location, the closest (e.g., maximum) similarity value s_{σ}_{ᵢ}, and the target image frame I_{LR}^{T}. The super-resolution image frame I_{SR}^{T} is generated at the target time step as a function of all the query tokens in the target image frame, value embeddings of the selected frames at a location corresponding to the index location of each query token, and the closest similarity values. The process of recovering the T^{th} HR frame I_{SR}^{T} can be further expressed as:

$${I}_{SR}^{T} = {T}_{traj} ( Q , K , V , 𝒯 ) = R ( \begin{matrix}{A}_{traj} \\ {τ}_{i} ∈ T\end{matrix} ( {q}_{{τ}_{i}^{T}} , {k}_{{τ}_{i}^{t}} , {v}_{{τ}_{i}^{t}} ) ) + U ( {I}_{LR}^{T} ) . \qquad ( 9 )$$

Here, Tₜᵣₐⱼ denotes the trajectory-aware transformer. Aₜᵣₐⱼ denotes the trajectory-aware attention. R represents a reconstruction network followed by a pixel-shuffle layer operatively configured to resize feature maps to the desired size. U represents an upsampling operation (e.g., a bicubic upsampling operation). FIG. 1 shows an example architecture of a trajectory-aware attention module (including example values of q, k, and v) followed by the reconstruction network R and the upsampling operation U, which generate the HR frame I_{SR}^{T}. ⊙ and ⊕ indicate multiplication and element-wise addition, respectively. σᵢ indicates a trajectory of [symbol] . By introducing trajectories into the transformer in TTVSR, computational expense of the attention calculation can be significantly reduced because it can avoid spatial dimension computation compared with vanilla vision transformers.

Based on equation (8), the attention calculation in equation (9) can be formulated as:

$${A}_{traj} ( {q}_{{τ}_{i}^{T}} , {k}_{{τ}_{i}} , {v}_{{τ}_{i}} ) = C ( {q}_{{τ}_{i}^{T}} , {s}_{{τ}_{i}} ⊙ {v}_{{τ}_{i}^{{h}_{{τ}_{i}}}} ) . \qquad ( 10 )$$

Here, a trajectory-aware attention result Aₜᵣₐⱼ is generated based upon the query token q_{τ}_{ᵢ}^{T}, the value embedding

$${v}_{{τ}_{i}^{{h}_{{τ}_{i}}}}$$

of the selected frame h_{σ}_{ᵢ} at the location along the trajectory σᵢ corresponding to the index location of the query token q_{τ}_{ᵢ}^{T}, and the closest (e.g., maximum) similarity value s_{τ}_{ᵢ}. In the example of equation (10), the query token q_{τ}_{ᵢ}^{T} is concatenated with a product of the similarity value sq and the value embedding

$${v}_{{τ}_{i}^{{h}_{{τ}_{i}}}}$$

of the selected frame. The operator ⊙ denotes multiplication. C denotes a concatenation operation. As introduced above, weighting the attention result Aₜᵣₐⱼ by the soft attention value (closes, e.g., maximum, similarity value) s_{σ}_{ᵢ} reduces the impact of less-relevant tokens, which have relatively low similarity values when compared to the query token, while increasing the contribution of tokens that are more like the query token. In general, features from the whole sequence of images are integrated in the trajectory-aware attention. This allows the attention calculation to be focused along a spatio-temporal trajectory, mitigating the computational cost.

As introduced above, the trajectory-aware attention result is output to the image reconstruction network R to thereby cause the image reconstruction network to output an image feature map for the super-resolution image frame. Further, in some examples, the computing system 102 is configured to upsample the target image frame and map the output of the image reconstruction network to the upsampled target image frame to generate the super-resolution image frame. Since the location map [symbol] ^{t} in equation (4) is an interchangeable formulation of trajectory σᵢ in equation (9), the TTVSR can be further expressed as:

$${I}_{SR}^{T} = {T}_{traj} ( Q , K , V , ℒ ) = R ( \begin{matrix}{A}_{traj} \\ t , m , n\end{matrix} ( {q}_{{ℒ}_{m , n}^{T}} , {k}_{{ℒ}_{m , n}^{t}} , {v}_{{ℒ}_{m , n}^{t}} ) ) + U ( {I}_{LR}^{T} ) . \qquad ( 11 )$$

Here, m∈[1, H], n∈[1, W], and t∈[1, T−1]. In this formulation, the coordinate system in the transformer is transformed from the one defined by trajectories to a group of aligned matrices (e.g., the location maps). Such a design has two advantages: first, the location maps provide a more efficient way to enable the TTVSR to directly leverage information from a distant video frame. Second, as trajectory is a widely used concept in videos, the methods and devices disclosed herein can be applied to increase the efficiency and power of other video tasks.

The following paragraphs provide additional details regarding the training of the trajectory-aware transformer model of FIG. 1. In some examples, the image reconstruction network R, the visual token embedding network Φ used to generate the query tokens Q and the key tokens K, and the value embedding network φ used to generate the value embeddings V are trained together on an image-reconstruction task. In some such examples, during a training phase, the computing system 102 is configured to receive training data including, as input, a training sequence of low-resolution image frames, and as ground-truth output, a corresponding sequence of high-resolution image frames. The computing system 102 is further configured to train the visual token embedding network Φ, the value embedding network φ, and the image reconstruction network R on the training data to output a run-time super-resolution image frame (e.g., I_{SR}^{T}) based upon a run-time input image sequence. Accordingly, and in one potential advantage of the present disclosure, training the visual token embedding network Φ, the value embedding network p, and the image reconstruction network R together can result in higher resolution output and reduced training time relative to training these networks independently.

In examples where the motion estimation network H comprises a neural network, the computing system 102 is configured to train the neural network by receiving, during a training phase, training data including, as input, a training sequence of image frames, and as ground-truth output, a ground-truth optical flow between image frames in the training sequence. The neural network is trained on the training data to output an optical flow (e.g., O_{T+1}) between a run-time input image frame and a successive run-time input image frame. In this manner, the neural network is trained to output a representation of an object's motion between successive image frames.

In some examples, training the neural network comprises obtaining a neural network that is pre-trained for motion-estimation (e.g., SPYNET), and fine-tuning the pre-trained neural network. Fine-tuning a pre-trained neural network may be less computationally demanding than training a neural network from scratch, and the fine-tuned neural network may outperform neural networks that are randomly initialized.

To leverage the whole sequence, a bidirectional propagation scheme is adopted, where features in different frames can be propagated backward and forward, respectively. To reduce consumption in terms of time and memory, visual tokens of different scales are generated from different frames. Features from adjacent frames are finer, so tokens of size 1×1 are generated. Features from a long distance are coarser, so these frames are selected at a certain time interval and tokens of size 4×4 are generated. Kernels of size 4×4, 6×6, and 8×8 are used for cross-scale feature tokenization. During training, a cosine annealing scheme and an Adam optimizer with β₁=0.9 and β₂=0.99 are used. The learning rates of the motion estimation and other parts are set as 1.25×10⁻⁵ and 2×10⁻⁴, respectively. The batch size was set as 8 and the input patch size as 64×64. For ease of comparison, the training data was augmented with random horizontal flips, vertical flips, and 90-degree rotations. To enable long-range sequence capability, sequences with a length of 50 were used as inputs. Charbonnier penalty loss is applied on whole frames between the ground-truth image I_{HR} and restored SR frame I_{SR}, which can be defined by [symbol] =\sqrt{∥I_{HR}−I_{SR}∥²+ε²}. To stabilize the training of TTVSR, the weights of the motion estimation module were fixed in the first 5K iterations and made trainable later. The total number of iterations is 400K.

The following paragraphs provide additional details regarding an example implementation of TTVSR. TTVSR was evaluated and compared in performance with other approaches on two datasets: REDS ([NPL21]) and VIMEO-90K ([NPL22]). REDS contains a total of 300 video sequences, in which 240 were used for training, 30 were used for validation, and 30 were used for testing. Each sequence contains 100 frames with a resolution of 720×1280. To create training and testing sets, four sequences were selected as the testing set, which is referred to as “REDS4”. The training and validation sets were selected from the remaining 266 sequences. VIMEOVIMEO-90K contains 64,612 sequences for training and 7,824 for testing. Each sequence contains seven frames with a resolution of 448×256. For ease of comparison, TTVSR was evaluated with 4× downsampling by using two degradations: 1) bicubic downsampling in MATLAB provided by The MathWorks, Inc. of Natick, Massachusetts (hereinafter referred to as “BI”), and 2) Gaussian filter with a standard deviation of σ=1.6 and downsampling (hereinafter referred to as “BD”). The BI degradation was applied on REDS4 and the BD degradation was applied on VIMEOVIMEO-90K-T, Vid4 ([NPL 23]), and UDM10 ([NPL16]). Peak signal-to-noise ratio (PSNR) and structural similarity index (SSIM) were used as evaluation metrics.

TTVSR was compared with 15 other methods. These methods can be summarized into three categories: single image super-resolution (SISR), sliding window-based methods, and recurrent structure-based methods. For ease of comparison, the respective performance parameters were obtained from the original publications related to each technique, or results were reproduced using original officially released models.

The proposed TTVSR technique described herein was compared with other SOTA methods on the REDS dataset. As shown in Table 1, these approaches were categorized according to the frames used in each inference. Among them, since one LR frame is used, the performance of SISR methods was relatively low. MuCAN and VSR-T use attention mechanisms in a sliding window, which resulted in a significant increase in performance over the SISR methods. However, they do not fully utilize all of the texture information available in the sequence. BasicVSR and IconVSR attempted to model the whole sequence through hidden states. Nonetheless, the vanishing gradient poses a challenge for long-term modeling, resulting in losing information at a distance. In contrast, TTVSR linked relevant visual tokens together along the same trajectory in an efficient way. TTVSR also used the whole sequence to recover lost textures. As a result, TTVSR achieved a result of 32.12 dB PSNR and significantly outperformed Icon-VSR by 0.45 dB on REDS4. This demonstrates the power of TTVSR in long-range modeling.

TABLE 1
Quantitative comparison (PSNR↑ and SSIM↑) on the REDS4 dataset for 4×
video super-resolution. The results were tested on RGB channels. The two strongest
performing models are underlined. #Frame indicates the number of input frames
used to perform an inference, and “r” indicates adoption of a recurrent structure.

| Method | #Frame | Clip_000 | Clip_011 | Clip_015 | Clip_020 | Average |
|---|---|---|---|---|---|---|
| Bicubic | 1 | 24.55/0.6489 | 26.06/0.7261 | 28.52/0.8034 | 25.41/0.7386 | 26.14/0.7292 |
| RCAN* | 1 | 26.17/0.7371 | 29.34/0.8255 | 31.85/0.8881 | 27.74/0.8293 | 28.78/0.8200 |
| CSNLN** | 1 | 26.17/0.7379 | 29.46/0.8260 | 32.00/0.8890 | 27.69/0.8253 | 28.83/0.8196 |
| TOFlow*** | 7 | 26.52/0.7540 | 27.80/0.7858 | 30.67/0.8609 | 26.92/0.7953 | 27.98/0.7990 |
| DUF^{†} | 7 | 27.30/0.7937 | 27.80/0.7858 | 31.55/0.8846 | 27.30/0.8164 | 28.63/0.8251 |
| EDVR | 7 | 28.01/0.8250 | 32.17/0.8864 | 34.06/0.9206 | 30.09/0.8881 | 31.09/0.8800 |
| MuCAN | 5 | 27.99/0.8219 | 31.84/0.8801 | 33.90/0.9170 | 29.78/0.8811 | 30.88/0.8750 |
| VSR-T | 5 | 28.06/0.8267 | 32.28/0.8883 | 34.15/0.9199 | 30.26/0.8912 | 31.19/0.8815 |
| Basic VSR | r | 28.39/0.8429 | 32.46/0.8975 | 34.22/0.9237 | 30.60/0.8996 | 31.42/0.8909 |
| Icon VSR | r | 28.55/0.8478 | 32.89/0.9024 | 34.54/0.9270 | 30.80/0.9033 | 31.67/0.8948 |
| TTVSR | r | 28.82/0.8566 | 33.47/0.9100 | 35.01/0.9325 | 31.17/0.9094 | 32.12/0.9021 |

*[NPL17].
**[NPL18].
***[NPL19].
^{†}[NPL20].

To further verify the generalization capabilities of TTVSR, trained TTVSR on the VIMEO-90K dataset and evaluated the results on Vid4. UDM10, and VIMEO-90K-T datasets, respectively. As shown in Table 2, on the Vid4, UDM10, and VIMEO-90K-T test sets, TTVSR achieved results of 28.40 dB, 40.41 dB, and 37.92 dB in PSNR, respectively, which was superior to other methods. Specifically, on the Vid4 and UDM10 datasets, TTVSR outperforms IconVSR by 0.36 dB and 0.38 dB respectively. At the same time, it was noticed that compared with the evaluation on VIMEO-90K-T with seven frames in each testing sequence, TTVSR outperformed other methods by a greater magnitude on datasets which have at least 30 frames per video. These results verified that TTVSR has strong generalization capabilities and is good at modeling the information in long-range sequences.

TABLE 2
Quantitative comparison (PSNR↑ and SSIM↑) on Vid4,
UDM10, and VIMEO-90K-T datasets for 4× video super-resolution.
All the results were calculated on a Y-channel in a YC_{B}C_{R} color
space. The two strongest performing models are underlined.

| Method | Vid4 | UDM10 | VIMEO-90K-T |
|---|---|---|---|
| Bicubic | 21.80/0.5246 | 28.47/0.8253 | 31.30/0.8687 |
| TOFlow | 25.85/0.7659 | 36.26/0.9438 | 34.62/0.9212 |
| FRVSR | 26.69/0.8103 | 37.09/0.9522 | 35.64/0.9319 |
| DUF | 27.38/0.8329 | 38.48/0.9605 | 36.87/0.9447 |
| RBPN | 27.17/0.8205 | 38.66/0.9596 | 37.20/0.9458 |
| RLSP | 27.48/0.8388 | 38.48/0.9606 | 36.49/0.9403 |
| EDVR | 27.85/0.8503 | 39.89/0.9686 | 37.81/0.9523 |
| TDAN | 26.86/0.8140 | 38.19/0.9586 | 36.31/0.9376 |
| TGA | 27.59/0.8419 | 39.05/0.9634 | 37.59/0.9516 |
| RSDN | 27.92/0.8505 | 39.35/0.9653 | 37.23/0.9471 |
| BasicVSR | 27.96/0.8553 | 39.96/0.9694 | 37.53/0.9498 |
| IconVSR | 28.04/0.8570 | 40.03/0.9694 | 37.84/0.9524 |
| TTVSR | 28.40/0.8643 | 40.41/0.9712 | 37.92/0.9526 |

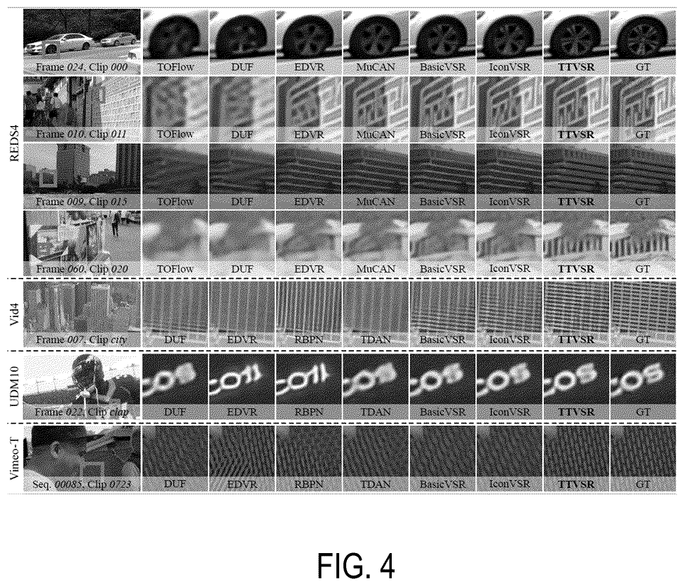

To further compare visual qualities of different approaches, FIG. 4 shows visual results generated by TTVSR and other methods on four different test sets. For ease of comparison, either the originally published SR images released for a given approach were obtained or officially released models were used to generate the results. It can be observed that TTVSR greatly increased visual quality relative to other approaches, especially for areas with detailed textures. For example, in the fourth row in FIG. 4, TTVSR recovered more striped details from the stonework in the oil painting. These results verified that TTVSR can utilize textures from relevant tokens to produce finer results than other methods.

In many applications, model sizes are balanced against computational costs. To avoid gaps between devices using different hardware, two hardware-independent metrics were used, including the number of parameters (#Params) and floating point operations per second (FLOPs). As shown in Table 3, the FLOPs were computed with a LR input of size 180×320 and ×4 upsampling settings. Compared with IconVSR, TTVSR achieved higher performance while keeping comparable #Params and FLOPs. Additionally, TTVSR is much lighter than MuCAN, which is another attention-based method. This improved performance mainly benefits from the use of trajectories in the attention calculation, which significantly reduces computational costs.

TABLE 3
Comparison of params, FLOPs and numbers. FLOPs were computed
on one LR frame with a size of 180 × 320 and ×4 upsampling
on the REDS4 dataset.

| Method | #Params(M) | FLOPs(T) | PSNR/SSIM |
|---|---|---|---|
| DUF | 5.8 | 2.34 | 28.63/0.8251 |
| RBPN | 12.2 | 8.51 | 30.09/0.8590 |
| EDVR | 20.6 | 2.95 | 31.09/0.8800 |
| MuCAN | 13.6 | >1.07 | 30.88/0.8750 |
| BasicVSR | 6.3 | 0.33 | 31.42/0.8909 |
| IconVSR | 8.7 | 0.51 | 31.67/0.8948 |
| TTVSR | 6.8 | 0.61 | 32.12/0.9021 |

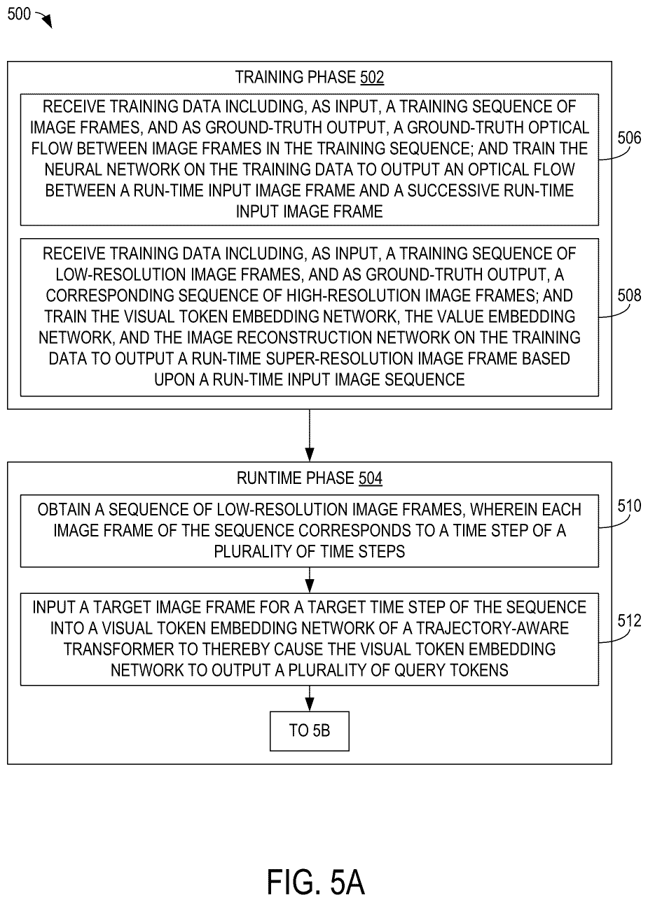

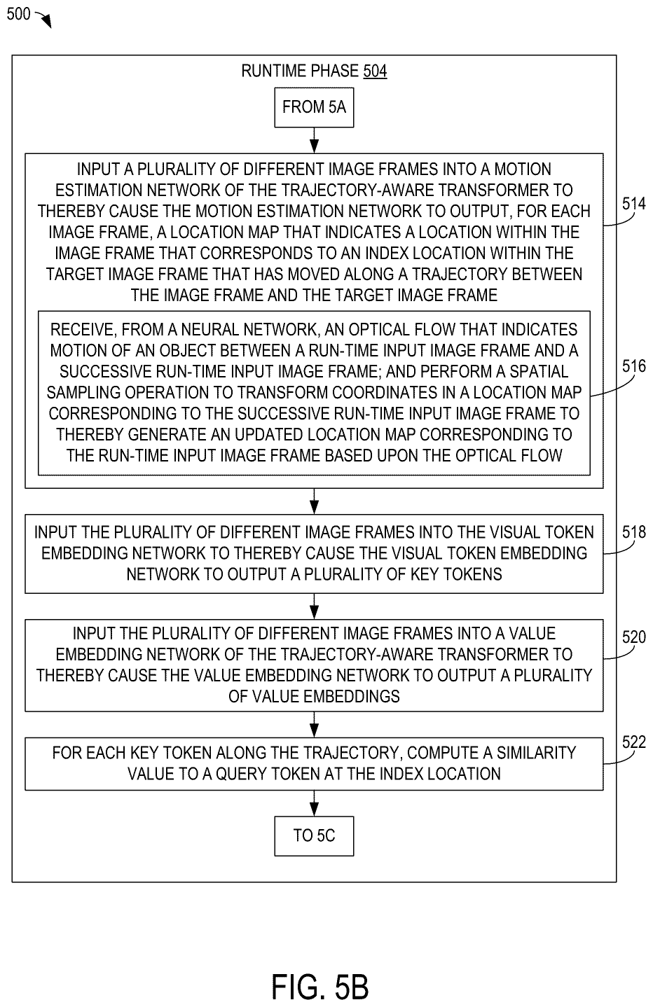

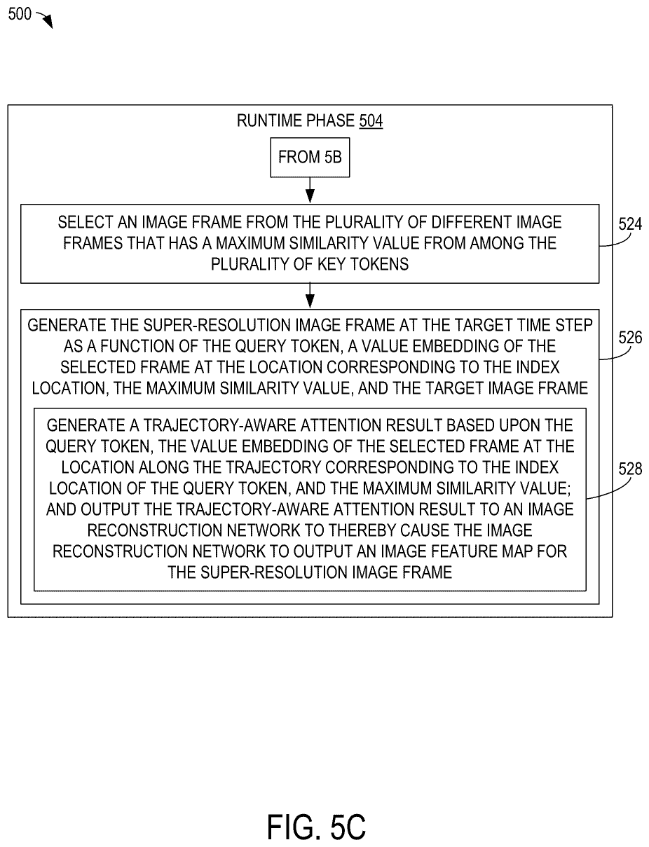

With reference now to FIGS. 5A-5C, a flowchart is illustrated depicting an example method 500 for generating a super-resolution image frame from a sequence of low-resolution images frames. The following description of method 500 is provided with reference to the software and hardware components described above and shown in FIGS. 1-4 and 6, and the method steps in method 500 will be described with reference to corresponding portions of FIGS. 1-4 and 6 below. It will be appreciated that method 500 also may be performed in other contexts using other suitable hardware and software components.

It will be appreciated that the following description of method 500 is provided by way of example and is not meant to be limiting. It will be understood that various steps of method 500 can be omitted or performed in a different order than described, and that the method 500 can include additional and/or alternative steps relative to those illustrated in FIGS. 5A-5C without departing from the scope of this disclosure.

With reference first to FIG. 5A, the method 500 includes steps performed in a training phase 502 and a runtime phase 504. As introduced above, in some examples, the motion estimation network (e.g., the motion estimation network H of FIG. 1) comprises a neural network. Accordingly, during the training phase 502, the method 500 may include receiving training data at 506. The training data includes, as input, a training sequence of image frames, and as ground-truth output, a ground-truth optical flow between image frames in the training sequence. Step 506 further comprises training the neural network on the training data to output an optical flow between a run-time input image frame and a successive run-time input image frame. In this manner, the neural network is trained to output a representation of an object's motion between successive image frames.

In some examples, during the training phase 502, the method 500 comprises training a visual token embedding network (e.g., the visual token embedding network Φ of FIG. 1), a value embedding network (e.g., the value embedding network φ of FIG. 1), and an image reconstruction network (e.g., the reconstruction network R of FIG. 1) at 508. To train these networks, step 508 includes receiving training data including, as input, a training sequence of low-resolution image frames, and as ground-truth output, a corresponding sequence of high-resolution image frames. The visual token embedding network, the value embedding network, and the image reconstruction network are trained on the training data to output a run-time super-resolution image frame (e.g., I_{SR}^{T}) based upon a run-time input image sequence. In some examples, training one or more of these networks together can result in higher resolution output and reduced training time relative to training each network independently.

In the runtime phase, at 510, the method 500 includes obtaining the sequence of low-resolution image frames, wherein each image frame of the sequence corresponds to a time step of a plurality of time steps. Givern the sequence of low-resolution image frames, the method 500 is configured to generate a HR version (e.g., I_{SR}^{T}) of one or more target frames (e.g., I_{LR}^{T}) using image textures recovered from one or more different image frames (I_{LR} {I_{LR}^{t}, t∈[1, T−1]}).

At 512, the method 500 includes inputting a target image frame for a target time step of the sequence into a visual token embedding network of a trajectory-aware transformer to thereby cause the visual token embedding network to output a plurality of query tokens. For example, the visual token embedding network Φ of FIG. 1 is used to extract the query tokens Q from a target image frame I_{LR}^{T}. As described above, the query tokens Q are compared to a plurality of key tokens K extracted from a plurality of different image frames to identify relevant textures from the different image frames that can be assembled to generate the super-resolution frame I_{SR}^{T}.

With reference now to FIG. 5B, the method 500 further comprises, at 514, inputting a plurality of different image frames into a motion estimation network of the trajectory-aware transformer to thereby cause the motion estimation network to output, for each image frame, a location map that indicates a location within the image frame that corresponds to an index location within the target image frame that has moved along a trajectory between the image frame and the target image frame. For example, the computing system 102 is configured to input the plurality of different image frames I_{LR} into the motion estimation network H, which generates a location map [symbol] ^{t} for each image frame I_{LR}^{t}. The location maps enable the trajectory to be computed in a lightweight and computationally efficient manner relative to the use of other techniques, such as feature alignment and global optimization.

In some examples, at 516, the motion estimation network comprises a neural network and a spatial sampling matrix operation. In such examples, the method further comprises receiving, from the neural network, an optical flow that indicates motion of an object between a run-time input image frame and a successive run-time input image frame. The spatial sampling operation is performed to transform coordinates in a location map corresponding to the successive run-time input image frame to thereby generate an updated location map corresponding to the run-time input image frame based upon the optical flow. For example, the motion estimation network H of FIG. 1 is configured to output optical flow O_{T+1}, which can be sampled using grid sample in PYTORCH to generate the updated location maps * [symbol] ^{t}. In this manner, the location maps can be generated using a simple matrix operation.

At 518, the method 500 comprises inputting the plurality of different image frames into the visual token embedding network to thereby cause the visual token embedding network to output a plurality of key tokens. As described above, the visual token embedding network Φ is the same network Φ that is used to generate the plurality of query tokens Q. This enables the query tokens Q to be directly compared to the key tokens K to identify relevant textures for generating the super-resolution frame I_{SR}^{T}.

The method 500 further comprises, at 520, inputting the plurality of different image frames into a value embedding network of the trajectory-aware transformer to thereby cause the value embedding network to output a plurality of value embeddings. For example, the computing system 102 of FIG. 1 is configured to input the image frames I_{LR} into the value embedding network φ to generate the value embeddings V. The value embeddings V include the features used to recreate the HR image frame I_{SR}^{T}.

At 522, the method 500 comprises, for each key token along the trajectory, computing a similarity value to a query token at the index location. For example, the computing system 102 of FIG. 1 is configured to compare query tokens and key tokens to compute hard attention and soft attention h_{σ}_{ᵢ} and s_{σ}_{ᵢ}, respectively. The hard attention hi selects the most relevant image frame out of the sequence for reconstructing a queried portion of the target image frame. The soft attention s, is used to weight the impact of tokens by their relevance to the queried portion of the target image frame.

With reference now to FIG. 5C, the method 500 further comprises, at 524, selecting an image frame from the plurality of different image frames that has a closest (e.g., maximum) similarity value from among the plurality of key tokens. This image frame includes the most similar texture to the query token qᵢ^{T} and is thus the most relevant image frame out of the sequence to obtain information for reconstructing a portion of the target image frame represented by the query key.

At 526, the method 500 further comprises generating the super-resolution image frame at the target time step as a function of the query token, a value embedding of the selected frame at the location corresponding to the index location, the closest (e.g., maximum) similarity value, and the target image frame. For example, the computing system 102 of FIG. 1 is configured to generate the HR frame I_{SR}^{T} based on the query token q_{τ}_{ᵢ}^{T}, the value embedding

$${v}_{{τ}_{i}^{{h}_{{τ}_{i}}}}$$

of the selected frame h_{τ}_{ᵢ} at the location along the trajectory τᵢ corresponding to the index location of the query token q_{τ}_{ᵢ}^{T}, the closest (e.g., maximum) similarity value s_{τ}_{ᵢ}, and the target image frame I_{LR}^{T}.

In some examples, at 528, generating the super-resolution image frame comprises generating a trajectory-aware attention result based upon the query token, the value embedding of the selected frame at the location along the trajectory corresponding to the index location of the query token, and the closest (e.g., maximum) similarity value. For example, the trajectory-aware attention result Aₜᵣₐⱼ of equation (10) is generated based upon the query token q_{τ}_{ᵢ}^{T}, the value embedding

$${v}_{{τ}_{i}^{{h}_{{τ}_{i}}}} ,$$

and the closest (e.g., maximum) similarity value s_{τ}_{ᵢ}. The trajectory-aware attention result is output to an image reconstruction network (e.g., the reconstruction network R) to thereby cause the image reconstruction network to output an image feature map for the super-resolution image frame. In some examples, the output of the image reconstruction network is mapped to an upsampled target image frame, to thereby generate the super-resolution image frame.

The above-described systems and methods may be used to generate a super-resolution image frame from a sequence of low-resolution image frames. Introducing trajectories into a transformer model reduces the computational expense of generating the super-resolution image frame by computing attention on a subset of key tokens aligned to a query token along a trajectory. This enables the computing device to avoid expending resources on less-relevant portions of image frames. Additionally, location maps are used to generate the trajectories using lightweight and efficient matrix operations. This enables the trajectories to be generated in a less-intensive manner compared to other techniques, such as feature alignment and global optimization. Additionally, the above-described systems and methods can outperform other systems and methods at least on video sequence datasets in video super-resolution applications.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 6 schematically shows an example of a computing system 600 that can enact one or more of the devices and methods described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), wearable computing devices such as smart wristwatches and head mounted augmented reality devices, and/or other computing devices. In some examples, the computing system 600 may embody the computing system 102 and/or the client 104 of FIG. 1.

The computing system 600 includes a logic processor 602, volatile memory 604, and a non-volatile storage device 606. The computing system 600 may optionally include a display subsystem 608, input subsystem 610, communication subsystem 612, and/or other components not shown in FIG. 6.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module” and “program” may be used to describe an aspect of computing system 600 typically implemented in software by a processor to perform a particular function using portions of volatile memory, which function involves transformative processing that specially configures the processor to perform the function. Thus, a module or program may be instantiated via logic processor 602 executing instructions held by non-volatile storage device 606, using portions of volatile memory 604. It will be understood that different modules and/or programs may be instantiated from the same application, service, code block, object, library, routine, API, function, etc. Likewise, the same module and/or program may be instantiated by different applications, services, code blocks, objects, routines, APIs, functions, etc. The terms “module” and “program” may encompass individual or groups of executable files, data files, libraries, drivers, scripts, database records, etc.

When included, display subsystem 608 may be used to present a visual representation of data held by non-volatile storage device 606. The visual representation may take the form of a GUI. As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, or game controller. In some examples, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 612 may be configured to communicatively couple various computing devices described herein with each other, and with other devices. Communication subsystem 612 may include wired and/or wireless communication devices compatible with one or more different communication protocols. For example, the communication subsystem may be configured for communication via a wireless telephone network, or a wired or wireless local- or wide-area network. In some examples, the communication subsystem may allow computing system 600 to send and/or receive messages to and/or from other devices via a network such as the Internet.

The following paragraphs provide additional support for the claims of the subject application. One aspect provides a computing system, comprising: a processor; and a memory storing instructions executable by the processor to, obtain a sequence of image frames in a video, wherein each image frame of the sequence corresponds to a time step of a plurality of time steps; input a target image frame for a target time step of the sequence into a visual token embedding network of a trajectory-aware transformer to thereby cause the visual token embedding network to output a plurality of query tokens; input a plurality of different image frames into a motion estimation network of the trajectory-aware transformer to thereby cause the motion estimation network to output, for each image frame, a location map that indicates a location within the image frame that corresponds to an index location within the target image frame that has moved along a trajectory between the image frame and the target image frame; input the plurality of different image frames into the visual token embedding network to thereby cause the visual token embedding network to output a plurality of key tokens; input the plurality of different image frames into a value embedding network of the trajectory-aware transformer to thereby cause the value embedding network to output a plurality of value embeddings; for each key token along the trajectory, compute a similarity value to a query token at the index location; select an image frame from the plurality of different image frames that has a closest similarity value from among the plurality of key tokens; and generate a super-resolution image frame at the target time step as a function of the query token, a value embedding of the selected frame at the location corresponding to the index location, the closest similarity value, and the target image frame. In this aspect, the motion estimation network additionally or alternatively includes a neural network, and the instructions are additionally or alternatively executable to, during a training phase: receive training data including, as input, a training sequence of image frames, and as ground-truth output, a ground-truth optical flow between image frames in the training sequence; and train the neural network on the training data to output an optical flow between a run-time input image frame and a successive run-time input image frame. In this aspect, the instructions executable to train the neural network additionally or alternatively include instructions executable to fine-tune a pre-trained neural network. In this aspect, the neural network additionally or alternatively includes a spatial pyramid network. In this aspect, the motion estimation network additionally or alternatively comprises a neural network and a spatial sampling matrix operation, wherein the neural network is configured to output an optical flow that indicates motion of an image feature between a run-time input image frame and a successive run-time input image frame; and wherein the spatial sampling matrix operation is configured to transform coordinates in a location map corresponding to the successive run-time input image frame to thereby generate an updated location map corresponding to the run-time input image frame based upon the optical flow. In this aspect, the instructions are additionally or alternatively executable to generate a trajectory-aware attention result based upon the query token, the value embedding of the selected frame at the location along the trajectory corresponding to the index location of the query token, and the closest similarity value; and output the trajectory-aware attention result to an image reconstruction network to thereby cause the image reconstruction network to output an image feature map for the super-resolution image frame. In this aspect, the instructions are additionally or alternatively executable to upsample the target image frame and map the output of the image reconstruction network to the upsampled target image frame to generate the super-resolution image frame. In this aspect, the instructions are additionally or alternatively executable to, during a training phase: receive training data including, as input, a training sequence of low-resolution image frames, and as ground-truth output, a corresponding sequence of high-resolution image frames; and train the visual token embedding network, the value embedding network, and the image reconstruction network on the training data to output a run-time super-resolution image frame based upon a run-time input image sequence. In this aspect, the instructions executable to generate the trajectory-aware attention result additionally or alternatively comprise instructions executable to concatenate the query token with a product of the similarity value and the value embedding of the selected frame at the location along the trajectory corresponding to the index location of the query token. In this aspect, the sequence of the image frames additionally or alternatively comprises a prerecorded video, a streaming video, or a video conference. In this aspect, the instructions are additionally or alternatively executable to output the super-resolution image frame to a client. In this aspect, the instructions executable to compute the similarity value are additionally or alternatively executable to comprise instructions executable to compute a cosine similarity value between the query token at the index location and each key token along the trajectory. In this aspect, each location map additionally or alternatively comprises a matrix of locations within a respective image frame that each correspond to a target index location within the target image frame, and wherein the target index location is indicated by a position of a respective location element in the matrix. In this aspect, the instructions are additionally or alternatively executable to cross-scale image feature tokens.

Another aspect provides, at a computing system, a method for generating a super-resolution image frame from a sequence of low-resolution image frames, the method comprising: obtaining the sequence of low-resolution image frames, wherein each image frame of the sequence corresponds to a time step of a plurality of time steps; inputting a target image frame for a target time step of the sequence into a visual token embedding network of a trajectory-aware transformer to thereby cause the visual token embedding network to output a plurality of query tokens; inputting a plurality of different image frames into a motion estimation network of the trajectory-aware transformer to thereby cause the motion estimation network to output, for each image frame, a location map that indicates a location within the image frame that corresponds to an index location within the target image frame that has moved along a trajectory between the image frame and the target image frame; inputting the plurality of different image frames into the visual token embedding network to thereby cause the visual token embedding network to output a plurality of key tokens; inputting the plurality of different image frames into a value embedding network of the trajectory-aware transformer to thereby cause the value embedding network to output a plurality of value embeddings; for each key token along the trajectory, computing a similarity value to a query token at the index location; selecting an image frame from the plurality of different image frames that has a closest similarity value from among the plurality of key tokens; and generating the super-resolution image frame at the target time step as a function of the query token, a value embedding of the selected frame at the location corresponding to the index location, the closest similarity value, and the target image frame. In this aspect, the motion estimation network additionally or alternatively comprises a neural network and a spatial sampling matrix operation, and the method additionally or alternatively comprises: receiving, from the neural network, an optical flow that indicates motion of an object between a run-time input image frame and a successive run-time input image frame; and performing the spatial sampling operation to transform coordinates in a location map corresponding to the successive run-time input image frame to thereby generate an updated location map corresponding to the run-time input image frame based upon the optical flow. In this aspect, the motion estimation network additionally or alternatively comprises a neural network, and the method additionally or alternatively comprises, during a training phase: receiving training data including, as input, a training sequence of image frames, and as ground-truth output, a ground-truth optical flow between image frames in the training sequence; and training the neural network on the training data to output an optical flow between a run-time input image frame and a successive run-time input image frame. The method additionally or alternatively includes generating a trajectory-aware attention result based upon the query token, the value embedding of the selected frame at the location along the trajectory corresponding to the index location of the query token, and the closest similarity value; and outputting the trajectory-aware attention result to an image reconstruction network to thereby cause the image reconstruction network to output an image feature map for the super-resolution image frame. The method additionally or alternatively includes, during a training phase: receiving training data including, as input, a training sequence of low-resolution image frames, and as ground-truth output, a corresponding sequence of high-resolution image frames; and training the visual token embedding network, the value embedding network, and the image reconstruction network on the training data to output a run-time super-resolution image frame based upon a run-time input image sequence.

Another aspect provides a computing system, comprising: a processor; and a memory storing instructions executable by the processor to, obtain a sequence of image frames comprising a video conference, wherein each image frame of the sequence corresponds to a time step of a plurality of time steps; input a target image frame for a target time step of the sequence into a visual token embedding network of a trajectory-aware transformer to thereby cause the visual token embedding network to output a plurality of query tokens; input a plurality of different image frames into a motion estimation network of the trajectory-aware transformer to thereby cause the motion estimation network to output, for each image frame, a location map that indicates a location within the image frame that corresponds to an index location within the target image frame that has moved along a trajectory between the image frame and the target image frame; input the plurality of different image frames into the visual token embedding network to thereby cause the visual token embedding network to output a plurality of key tokens; input the plurality of different image frames into a value embedding network of the trajectory-aware transformer to thereby cause the value embedding network to output a plurality of value embeddings; for each key token along the trajectory, compute a similarity value to a query token at the index location; select an image frame from the plurality of different image frames that has a closest similarity value from among the plurality of key tokens; generate a super-resolution image frame at the target time step as a function of the query token, a value embedding of the selected frame at the location corresponding to the index location, the closest similarity value, and the target image frame; and output the super-resolution image frame to a client.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

Further, it will be appreciated that the terms “includes,” “including,” “has,” “contains,” variants thereof, and other similar words used in either the detailed description or the claims are intended to be inclusive in a manner similar to the term “comprising” as an open transition word without precluding any additional or other elements.

1. A computing system, comprising:
a processor; and
a memory storing instructions executable by the processor to,
obtain a sequence of image frames in a video, wherein each image frame of the sequence corresponds to a time step of a plurality of time steps;
input a target image frame for a target time step of the sequence into a visual token embedding network of a trajectory-aware transformer to thereby cause the visual token embedding network to output a plurality of query tokens;
input a plurality of different image frames into a motion estimation network of the trajectory-aware transformer to thereby cause the motion estimation network to output, for each image frame, a location map that indicates a location within the image frame that corresponds to an index location within the target image frame that has moved along a trajectory between the image frame and the target image frame;
input the plurality of different image frames into the visual token embedding network to thereby cause the visual token embedding network to output a plurality of key tokens;
input the plurality of different image frames into a value embedding network of the trajectory-aware transformer to thereby cause the value embedding network to output a plurality of value embeddings;
for each key token along the trajectory, compute a similarity value to a query token at the index location;
select an image frame from the plurality of different image frames that has a closest similarity value from among the plurality of key tokens; and
generate a super-resolution image frame at the target time step as a function of the query token, a value embedding of the selected frame at the location corresponding to the index location, the closest similarity value, and the target image frame.

2. The computing system of claim 1, wherein the motion estimation network comprises a neural network, and wherein the instructions are further executable to, during a training phase:
receive training data including,
as input, a training sequence of image frames, and
as ground-truth output, a ground-truth optical flow between image frames in the training sequence; and
train the neural network on the training data to output an optical flow between a run-time input image frame and a successive run-time input image frame.

3. The computing system of claim 2, wherein the instructions executable to train the neural network comprise instructions executable to fine-tune a pre-trained neural network.

4. The computing system of claim 2, wherein the neural network comprises a spatial pyramid network.

5. The computing system of claim 1, wherein the motion estimation network comprises a neural network and a spatial sampling matrix operation;
wherein the neural network is configured to output an optical flow that indicates motion of an image feature between a run-time input image frame and a successive run-time input image frame; and
wherein the spatial sampling matrix operation is configured to transform coordinates in a location map corresponding to the successive run-time input image frame to thereby generate an updated location map corresponding to the run-time input image frame based upon the optical flow.

6. The computing system of claim 1, wherein the instructions are further executable to:
generate a trajectory-aware attention result based upon the query token, the value embedding of the selected frame at the location along the trajectory corresponding to the index location of the query token, and the closest similarity value; and
output the trajectory-aware attention result to an image reconstruction network to thereby cause the image reconstruction network to output an image feature map for the super-resolution image frame.

7. The computing system of claim 6, wherein the instructions are further executable to upsample the target image frame and map the output of the image reconstruction network to the upsampled target image frame to generate the super-resolution image frame.

8. The computing system of claim 6, wherein the instructions are further executable to, during a training phase:
receive training data including,
as input, a training sequence of low-resolution image frames, and
as ground-truth output, a corresponding sequence of high-resolution image frames; and
train the visual token embedding network, the value embedding network, and the image reconstruction network on the training data to output a run-time super-resolution image frame based upon a run-time input image sequence.

9. The computing system of claim 6, wherein the instructions executable to generate the trajectory-aware attention result comprise instructions executable to concatenate the query token with a product of the similarity value and the value embedding of the selected frame at the location along the trajectory corresponding to the index location of the query token.

10. The computing system of claim 1, wherein the sequence of the image frames comprises a prerecorded video, a streaming video, or a video conference.

11. The computing system of claim 1, wherein the instructions are further executable to output the super-resolution image frame to a client.

12. The computing system of claim 1, wherein the instructions executable to compute the similarity value comprise instructions executable to compute a cosine similarity value between the query token at the index location and each key token along the trajectory.

13. The computing system of claim 1, wherein each location map comprises a matrix of locations within a respective image frame that each correspond to a target index location within the target image frame, and wherein the target index location is indicated by a position of a respective location element in the matrix.

14. The computing system of claim 1, wherein the instructions are further executable to cross-scale image feature tokens.

15. At a computing system, a method for generating a super-resolution image frame from a sequence of low-resolution image frames, the method comprising:
obtaining the sequence of low-resolution image frames, wherein each image frame of the sequence corresponds to a time step of a plurality of time steps;
inputting a target image frame for a target time step of the sequence into a visual token embedding network of a trajectory-aware transformer to thereby cause the visual token embedding network to output a plurality of query tokens;
inputting a plurality of different image frames into a motion estimation network of the trajectory-aware transformer to thereby cause the motion estimation network to output, for each image frame, a location map that indicates a location within the image frame that corresponds to an index location within the target image frame that has moved along a trajectory between the image frame and the target image frame;
inputting the plurality of different image frames into the visual token embedding network to thereby cause the visual token embedding network to output a plurality of key tokens;
inputting the plurality of different image frames into a value embedding network of the trajectory-aware transformer to thereby cause the value embedding network to output a plurality of value embeddings;
for each key token along the trajectory, computing a similarity value to a query token at the index location;
selecting an image frame from the plurality of different image frames that has a closest similarity value from among the plurality of key tokens; and
generating the super-resolution image frame at the target time step as a function of the query token, a value embedding of the selected frame at the location corresponding to the index location, the closest similarity value, and the target image frame.

16. The method of claim 15, wherein the motion estimation network comprises a neural network and a spatial sampling matrix operation, the method further comprising:
receiving, from the neural network, an optical flow that indicates motion of an object between a run-time input image frame and a successive run-time input image frame; and
performing the spatial sampling operation to transform coordinates in a location map corresponding to the successive run-time input image frame to thereby generate an updated location map corresponding to the run-time input image frame based upon the optical flow.

17. The method of claim 15, wherein the motion estimation network comprises a neural network, the method further comprising, during a training phase:
receiving training data including,
as input, a training sequence of image frames, and
as ground-truth output, a ground-truth optical flow between image frames in the training sequence; and
training the neural network on the training data to output an optical flow between a run-time input image frame and a successive run-time input image frame.

18. The method of claim 15, further comprising:
generating a trajectory-aware attention result based upon the query token, the value embedding of the selected frame at the location along the trajectory corresponding to the index location of the query token, and the closest similarity value; and
outputting the trajectory-aware attention result to an image reconstruction network to thereby cause the image reconstruction network to output an image feature map for the super-resolution image frame.

19. The method of claim 18, further comprising, during a training phase:
receiving training data including,
as input, a training sequence of low-resolution image frames, and
as ground-truth output, a corresponding sequence of high-resolution image frames; and
training the visual token embedding network, the value embedding network, and the image reconstruction network on the training data to output a run-time super-resolution image frame based upon a run-time input image sequence.

20. A computing system, comprising:
a processor; and
a memory storing instructions executable by the processor to,
obtain a sequence of image frames comprising a video conference, wherein each image frame of the sequence corresponds to a time step of a plurality of time steps;
input a target image frame for a target time step of the sequence into a visual token embedding network of a trajectory-aware transformer to thereby cause the visual token embedding network to output a plurality of query tokens;
input a plurality of different image frames into a motion estimation network of the trajectory-aware transformer to thereby cause the motion estimation network to output, for each image frame, a location map that indicates a location within the image frame that corresponds to an index location within the target image frame that has moved along a trajectory between the image frame and the target image frame;
input the plurality of different image frames into the visual token embedding network to thereby cause the visual token embedding network to output a plurality of key tokens;
input the plurality of different image frames into a value embedding network of the trajectory-aware transformer to thereby cause the value embedding network to output a plurality of value embeddings;
for each key token along the trajectory, compute a similarity value to a query token at the index location;
select an image frame from the plurality of different image frames that has a closest similarity value from among the plurality of key tokens;
generate a super-resolution image frame at the target time step as a function of the query token, a value embedding of the selected frame at the location corresponding to the index location, the closest similarity value, and the target image frame; and
output the super-resolution image frame to a client.
